(19) United States
(12) Patent Application Publication
(10) Pub. No.: US 2025/0018626 A1
(43) Pub. Date: Jan. 16, 2025

(54) METHOD FOR PRODUCING A SEALING ELEMENT, SEALING ELEMENT AND USE OF A SEALING ELEMENT PRODUCED ACCORDING TO SUCH A METHOD

(71) Applicant: VR AUTOMOTIVE DICHTUNGSSYSTEME GMBH, Auengrund-Crock (DE)

(72) Inventors: Timmy BOESERT, Auengrund-Crock (DE); Martin SCHAUB, Auengrund-Crock (DE); Stephan STEINKE, Auengrund-Crock (DE)

(21) Appl. No.: 18/708,174

(22) PCT Filed: Dec. 15, 2022
(86) PCT No.: PCT/EP2022/086198

§ 371 Date: May 7, 2024

(30) Foreign Application Priority Data
Dec. 20, 2021 (DE) 10 2021 133 871.9

(51) Int. Cl. B29C 45/14; B29C 43/28; B29K 21/00; B29L 31/26

(52) U.S. Cl. CPC B29C 45/14418; B29C 43/28; B29K 2021/006; B29L 2031/26

(57) ABSTRACT

A method for manufacturing a sealing element with a rectangular shape. The sealing element has a first and a second direction of extension as well as two or more openings. The method is technically simpler and more cost-effective than known manufacturing methods since the sealing element is formed by an injection molding process or a compression molding process in an unwound mold, after which a cylindrical end contour is formed. A sealing element produced through the method and its use are also described.

The present invention relates to a sealing element having a substantially rectangular basic shape with a first direction of extension and a second direction of extension and a plurality of openings, to a method for manufacturing such a sealing element and to the use of a sealing element manufactured by such a method.

Such a sealing element is known, for example, from EP 3 385 583 A1 or WO 2021/087106.

In many “old” fields of technology, such as the established automotive industry in Germany, the focus is no longer exclusively on the development of new products. Instead, the focus is on improving existing technologies to increase efficiency and reduce costs. This applies to all levels, from the engine to the washer. In addition to the above-mentioned requirements, the increase in functions also poses the challenge of solving tasks in ever smaller installation spaces.

One example of the problem described above is the thermal management module of a motor vehicle. Due in part to the increasing electrification of the drivetrain, a large number of coolant flows, sometimes with different temperature levels, need to be regulated nowadays. For this reason, rotary slide valves with several internal channels and several connections are increasingly being used. These are very compact and, thanks to their different positions, can simultaneously realise and control different coolant flows as required. A rotary slide valve of this type requires a special seal that seals between the housing, which is provided with various connections, and the rotary slide valve arranged inside the housing in such a way that only the intended flows through the valve body are possible.

The aforementioned EP 3 385 583 A1 was identified as the closest prior art. It describes such a multi-port valve consisting of a housing with an inner cavity and several connections, a rotatable cylindrical valve body equipped with internal channels, which is arranged inside the cavity of the housing, and a sealing element. The sealing element has an essentially sleeve-like shape and has several openings. It is arranged in such a way that it surrounds the cylindrical valve body within the cavity of the housing.

WO 2021/087106, also mentioned at the beginning, has a sealing element similar to EP 3 385 583 A1. It differs from the latter in that it does not have a complete sleeve shape, but rather this is interrupted over the entire axial length in a certain section.

What the two sealing elements in the above-mentioned documents have in common is that their basic shape corresponds at least partially to that of a hollow cylinder or sleeve, even when not installed. The sophisticated, three-dimensional shape places high demands on the manufacture of the sealing element. Such an injection moulding process requires a complex injection moulding tool with several slides or at least one downstream punching or cutting process. This results in high production costs for the manufacturer, which means that the individual part price for the customer is also high.

Accordingly, it is the task of the invention to describe a manufacturing process for a sealing element and a sealing element which is technically simpler and thus less expensive to manufacture than is the case with sealing elements known from the prior art. The use of a sealing element manufactured according to such a method is a further aspect of the invention.

This task is solved by a method for manufacturing a sealing element with an essentially rectangular basic shape with a first direction of extension and a second direction of extension as well as a plurality of openings, which is characterised in that the sealing element is first formed in an unwound mould by means of an injection moulding process or a compression moulding process and a virtually cylindrical final contour is then formed. Advantageous further embodiments are the subject of the further dependent process claims 2 to 9.

The further aspects are solved by a sealing element manufactured according to such a method according to claim 10 and its use according to claim 23. Advantageous further embodiments of the sealing element are the subject of the dependent claims 11 to 22, while advantageous further embodiments of its use are the subject of the dependent claims 24 to 26.

In its most general form, the present invention provides for the first time a manufacturing process for a sealing element, in which the initial shaping is carried out by means of injection moulding or compression moulding in an unwound mould before a virtually cylindrical final contour is formed. Compared to the prior art, such a process represents a cost-effective and easy-to-control option for manufacturing a virtually cylindrical sealing element that can be used in this way. Complicated three-dimensional geometries of the vulcanisation tool, additional slides or further process steps for post-treatment and/or further treatment can be dispensed with.

For primary moulding, an elastomeric material is heated and moulded under pressure in a vulcanisation tool. The right combination of temperature, pressure and other parameters is crucial in order to obtain the viscosity of the elastomeric material required for vulcanisation. In addition to the described embodiment with an elastomeric material, embodiments in which at least two elastomeric materials are used are also conceivable. These can either be mixed homogeneously or arranged heterogeneously. The latter offers, for example, the possibility of realising a core made of one elastomeric material and a coating made of a second elastomeric material.

The cavity of the vulcanisation tool corresponds to the unwound shape of the sealing element to be manufactured. For a first embodiment of the manufacturing method according to the invention, the cavity has a substantially rectangular basic shape with a first direction of extension and a second direction of extension arranged orthogonally thereto. Accordingly, the first direction of extension and the second direction of extension span a substantially rectangular frame which surrounds a plurality of openings. The openings are separated from one another by webs which are connected to the frame and are also formed during the injection moulding process or compression moulding process.

If the aim is to obtain a sealing element with properties that cannot be achieved with elastomer materials alone, it is also possible to insert an additional component, such as a film, into the vulcanisation tool and chemically or mechanically bond the sealing element to it. The bond with the additional component is thus already created when the sealing element is formed.

Following the injection moulding or compression moulding process, the resulting sealing element is rolled up into an almost cylindrical end contour. The first direction of extension corresponds to the circumferential direction of the cylindrical end contour, while the second direction of extension is coaxial to the imaginary centre axis. As a result, elastic deformation by bending occurs in the first direction of extension, but not in the second direction of extension.

According to an advantageous embodiment, it is proposed to give individual segments of the sealing element a partially cylindrical shape during the injection moulding process or compression moulding process in order to reduce the prestressing introduced by the elastic deformation. For this purpose, the vulcanisation tool is designed in such a way that all sections of the frame that are aligned along the first direction of extension, as well as any webs running in the same direction, have correspondingly curved geometries. Excluded from this are those points in the first direction of extension of the frame at which the webs running in the second direction of extension meet the frame. In highly abstract terms, it can be said that the cavity of the vulcanisation tool and thus also the sealing element manufactured with it after the injection moulding process or compression moulding process has a wave-like shape. The points at which the webs running in the second direction of extension meet the frame represent the crests of the waves, while the centres of the preformed segments represent the troughs of the waves.

In a further embodiment of the invention, one or more starting materials of an elastomer and/or a polymer are used as the material. In particular, variants are also conceivable in which some sections of the sealing element consist of an elastomer and other sections consist of a polymer. Both elastomers and polymers have a good ratio of flexibility and frictional resistance in their final form and are frequently used as sealing materials.

In an advantageous embodiment, the sealing element is tempered after the shaping vulcanisation process. This increases the bonds between the molecules and improves the elastic properties of the sealing element.

In another advantageous embodiment, the sealing element is partially or completely coated. A PTFE coating is conceivable here, for example, on all sections that form a dynamic sealing surface during subsequent operation. Such a coating can be used to reduce the frictional resistance of the corresponding sliding pairing without negatively affecting the sealing properties.

According to one or more claims for use, which are described in more detail below, the sealing element according to the invention serves to seal a cylindrical rotary slide valve of a medium distributor with respect to its housing. Such medium distributors are used in particular in applications in which several fluid flows, which are essentially independent of one another, have to be regulated simultaneously. The various fluid flows can differ in terms of their temperature, pressure and volume flow, among other things. The latter in particular may require differently sized connections in the housing and channels in the cylindrical rotary valve. Accordingly, further embodiments of the sealing element according to the invention are conceivable in which individual or several of the openings have different sizes. Of course, variants are also conceivable in which several openings have the same size and individual or several other openings have a different size.

Based on the potentially different sizes described above, embodiments in which the openings of the sealing element have different shapes are also conceivable. Depending on their suitability for the individual application, the openings can have rectangular, round or elliptical shapes, for example, although other geometric shapes are of course also conceivable. In particular, this also includes asymmetrical shapes. A single sealing element can also have openings of different shapes.

In addition to the size and shape, the arrangement of the plurality of openings also depends on the application. One or more of the openings can be arranged next to each other in both the first and second directions. A recurring pattern or symmetry in the arrangement is possible, but asymmetrical arrangements are also conceivable.

The frames and webs of the sealing element can have an essentially rectangular cross-sectional profile. It is also possible for the cross-sectional profile to have a round, triangular, curved or other shape. The selection is made on a case-by-case basis depending on the individual requirements.

In one use of the sealing element according to the invention, it provides a static seal against the housing of a medium distributor and a dynamic seal against the cylindrical rotary slide valve. In order to ensure that the sealing element cannot rotate relative to the housing of the medium distributor during operation, in one embodiment it has one or more grooves on the radially outer side of the almost cylindrical end contour. One or more corresponding springs, which are provided on the radially inner side of the housing of the medium distributor, engage in this groove or these grooves.

It is also possible to reverse the tongue and groove connection described above. According to a further embodiment, one or more springs are therefore provided on the radially outer side of the almost cylindrical end contour of the sealing element. These in turn engage in one or more corresponding grooves, which are arranged on the radially inner side of the housing of the medium distributor. The springs are an inherent part of the sealing element, which are formed during the vulcanisation process.

In particular with the embodiments described above, which teach a tongue-and-groove connection between the sealing element and the surrounding housing of a medium distributor, the sealing element can also fulfil the function of a bearing shell for the cylindrical rotary valve. Radial forces can thus be absorbed via the sealing element if its rigidity is sufficiently high. This offers the possibility of saving one or more bearings of the shaft driving the cylindrical rotary slide, which in turn can bring advantages in terms of installation space and costs. Furthermore, overdetermination and axial misalignment between the cylindrical rotary slide valve and the housing of the medium distributor can be better compensated for via the dynamic sealing surface between the sealing element and the cylindrical rotary slide valve.

According to an alternative embodiment, it is possible for the sealing element to be rotationally fixed in relation to the cylindrical rotary valve, with which it consequently forms a static sealing surface. In this case, the dynamic sealing surface exists between the sealing element and the housing of the medium distributor that radially surrounds the sealing element. To ensure this relationship, the sealing element can have one or more grooves on the radially inner side of its cylindrical contour. One or more corresponding springs, which are provided on the radially outer side of the cylindrical rotary slide of the medium distributor, engage in this groove or these grooves.

It is also possible to reverse the tongue and groove connection described above. According to a further embodiment, one or more springs are therefore provided on the radially inner side of the almost cylindrical end contour of the sealing element. These in turn engage in one or more corresponding grooves, which are arranged on the radially outer side of the cylindrical rotary slide.

In the following, the present invention is illustrated in more detail with reference to the drawings. They show:

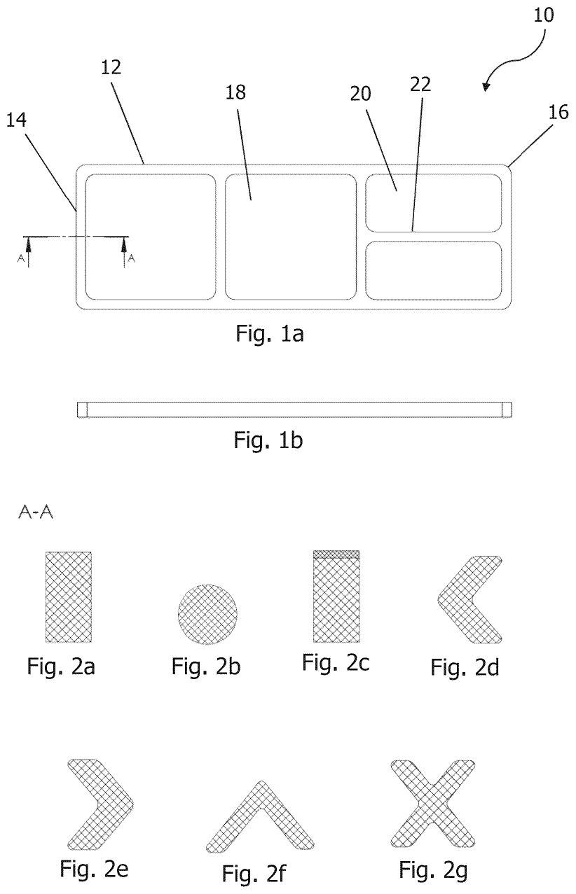

FIG. 1a top view of a first embodiment of a sealing element according to the invention;

FIG. 1b the sealing element according to the invention as shown in FIG. 1a in side view;

FIGS. 2a to 2g different cross-sectional profiles of a section of the sealing element according to the invention;

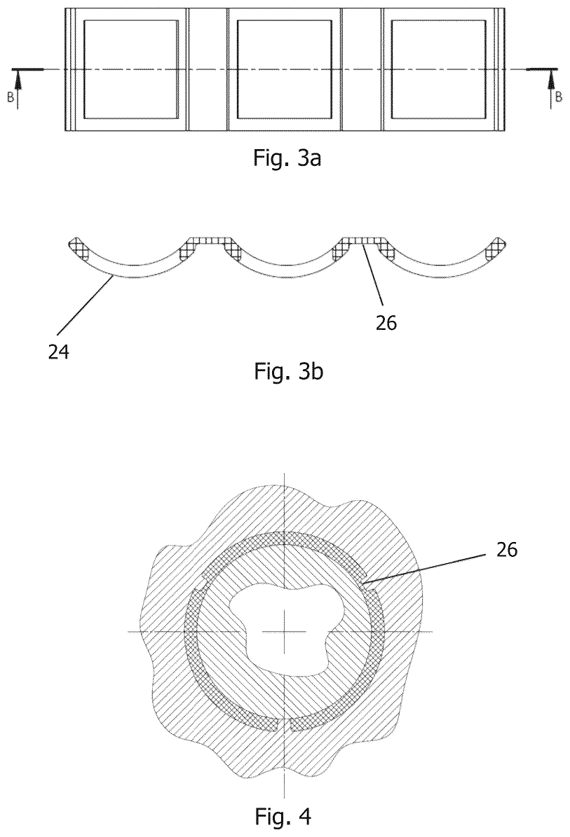

FIG. 3a a top view of a second embodiment of the sealing element according to the invention;

FIG. 3b a side view of the sealing element according to the invention as shown in FIG. 3a;

FIG. 4 the sealing element as shown in FIGS. 3a and 3b in its almost cylindrical end contour in the installed state;

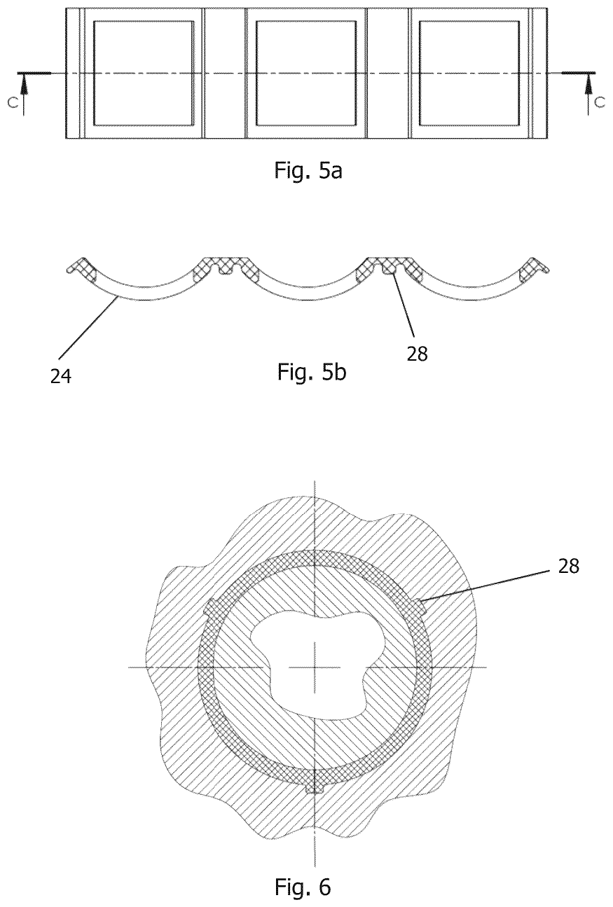

FIG. 5a top view of a third embodiment of the sealing element according to the invention;

FIG. 5b the sealing element according to FIG. 5a in side view;

FIG. 6 the sealing element according to FIGS. 5a and 5b in its almost cylindrical end contour in the installed state; and

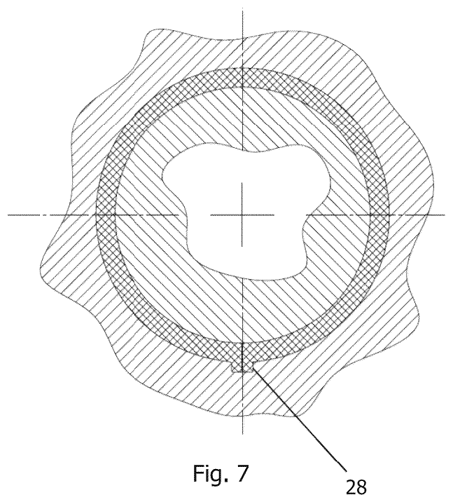

FIG. 7a fourth embodiment of the sealing element according to the invention in the installed state.

FIGS. 1a to 7 show various embodiments and states of a sealing element according to the invention. The process required to manufacture such a sealing element is explained with reference to these figures, without the individual process steps being illustrated by means of separate drawings.

FIG. 1a shows a top view of a first embodiment of a sealing element 10 according to the invention. As can be seen from the joint view with FIG. 1b, which shows a side view of the same sealing element 10 of FIG. 1a, this is a substantially flat and planar structure. The sealing element 10 comprises a first direction of extension 12 and a second direction of extension 14 arranged essentially orthogonally to this, by means of which a frame 16 of the sealing element 10 is spanned, which essentially has the shape of a rectangle. In addition, the sealing element 10 comprises several openings, some of which are provided in FIG. 1a with the reference signs 18 and 20 as examples. The openings 18, 20 are each separated from one another by webs 22, which connect either to further webs 22 or to the frame 16.

FIGS. 1a and 1b show a sealing element 10 as it is before the final step of a manufacturing process according to the invention. In order to obtain such a sealing element, the sealing element 10 is first moulded in an injection moulding process or compression moulding process. The cavity of the associated vulcanisation tool therefore has the exact shape of the sealing element 10 to be manufactured, but in an unwound form. In the final process step, the sealing element 10, which has been moulded in its unwound form, is rolled up by guiding the two sections of the frame 16, which are located in the second direction of extension 14, towards each other. This manufactures an almost cylindrical end contour, in which the original first direction of extension 12 runs along the circumference, while the original second direction of extension 14 is arranged coaxially to an imaginary centre axis of the cylindrical end contour. FIG. 4, which is discussed in detail below, shows a sealing element 10 rolled up in this way in its almost cylindrical end contour in the installed state.

FIGS. 2a to 2g show possible shapes of a cross-sectional profile of the frame 16 and/or the webs 22. As shown in FIG. 2a, such a cross-sectional profile can have a rectangular shape, whereby the inner and outer corners and edges can have a weaker or more pronounced rounding depending on the individual application. According to FIG. 2c, this can also be coated on one or more sides, preferably on the side that forms a dynamic sealing surface during operation. A PTFE coating, for example, is an option here. It is also possible for the sealing element 10 to consist of two materials that are bonded together during the vulcanisation process. A round cross-sectional shape is also conceivable (FIG. 2b), as is a triangular cross-sectional shape, which can be orientated differently (FIGS. 2d to 2f). In addition, a cross-shaped or X-shaped cross-sectional shape is also conceivable (FIG. 2g), as are other shapes not shown in FIGS. 2a to 2g. Preferably, all sections of the frame 16 and webs 22 of a sealing element 10 have the same cross-sectional shape. However, embodiments are also conceivable in which individual sections of the frame 16 and/or individual or several webs 22 have a different cross-sectional shape. The appropriate selection is made for each individual case based on the individual operating conditions.

FIGS. 3a and 3b show a further embodiment of the sealing element 10 according to the invention. The top view shown in FIG. 3a corresponds exactly to that in FIG. 1a. As can be seen from the corresponding side view in FIG. 3b, individual sections of the sealing element 10, which are located in the first direction of extension 12, are partially cylindrically preformed. On the one hand, this relates to the sections of the frame 16 that are located in the first direction of extension 12, but can also include the webs 22, which are also located in the first direction of extension 12. The radius of these partial shells 24 corresponds approximately to the radius of the sealing element 10 in its almost cylindrical end contour. Similar to the sealing element 10 of FIGS. 1a and 1b, the sealing element 10 of FIGS. 3a and 3b can be manufactured using a comparatively simple vulcanisation tool. To manufacture a sealing element 10 with such a shape, complex slides during the injection moulding process can be dispensed with, as can complex post-processing, for example punching or cutting.

One advantage of such an embodiment of the sealing element 10 preformed with partial shells 24 is that less bending stress is exerted on some parts of the sealing element 10 when forming the almost cylindrical end contour. This favours a more reliable fulfilment of its sealing function. It also reduces friction and the resulting section modulus, which can be considered when designing the actuator.

According to an advantageous embodiment, the sealing element 10 according to the invention is designed in such a way that its circumference contains one or more grooves 26 in the almost cylindrical end contour. These are already provided during the original moulding by a corresponding design of the vulcanisation tool. In the installed state, which is illustrated in FIG. 4, these grooves together with corresponding springs of a housing of a medium distributor, which encloses the sealing element 10 on its radially outer side, form a positive connection. This connection prevents rotation and thus ensures the correct position of the sealing element 10 in the housing.

FIGS. 5a and 5b show a further embodiment of the sealing element 10 according to the invention, in which the tongue-and-groove connection has been inverted compared to the embodiment example of FIGS. 3a and 3b. Accordingly, one or more springs 28 protrude from the almost cylindrical end contour of the sealing element 10 in a radially outer direction. This shape is also already provided for during the design of the vulcanisation tool for the original moulding.

As shown in FIG. 6, these one or more springs 28 correspond in the installed state with one or more corresponding grooves in the housing of the medium distributor. Analogous to the previous example, such a design prevents the sealing element 10 from rotating relative to the housing of the medium distributor.

In contrast, FIG. 7 shows an embodiment of the sealing element 10 that manages with a single spring 28. The desired anti-rotation lock is created by the interaction with a corresponding spring in the housing. The corresponding selection of an appropriate number of tongue and groove connections and their alignment is made for each individual case based on the individual operating conditions.

The latter embodiment example, in which the springs 28 are designed as part of the sealing element 10, allows for less localised losses in the height of the cross-sectional profile. The overall stability and rigidity of the sealing element 10 can therefore be increased. As the grooves are provided in the housing of the medium distributor in this design example, the diameter of the housing increases in order to maintain a minimum wall thickness. From this it can already be appreciated that the design of the tongue and groove connection must be selected for the individual application and based on the operating conditions.

### LIST OF REFERENCE NUMBERS

10 Scaling element
12 First direction of extension
14 Second direction of extension
16 Frame
18 Opening
20 Opening
22 Web
24 Partial shell
26 Groove
28 Spring

1.-26. (canceled)

27. A sealing element with a rectangular shape in an unwound state, the sealing element comprising:
a first direction of extension,
a second direction of extension,
a first opening,
a second opening, and
a cylindrical end contour,
wherein:
the sealing element is formed by an injection moulding process or a compression moulding process, and
the sealing element is manufactured from at least a first material and a second material, wherein the second material at least partially covers the first material in a third direction of extension, the third direction of extension arranged orthogonally to the first direction of extension and the second direction of extension.

28. The sealing element according to claim 27, wherein the second material completely covers the first material in the third direction of extension.

29. The sealing element according to claim 27, wherein the first direction of extension runs along the circumference of the cylindrical end contour and the second direction of extension runs parallel to a centre axis of the cylindrical end contour.

30. The sealing element according to claim 27, wherein at least one section of the sealing element has a partially cylindrical shape in the unwound state.

31. The sealing element according to claim 30, wherein the at least one section of the sealing element is aligned along the first direction of extension.

32. The sealing element according to claim 27, wherein the first opening and the second opening have a uniform size.

33. The sealing element according to claim 27, wherein the first opening and the second opening have different sizes.

34. The sealing element according to claim 27, wherein at least one of the first opening and the second opening has a symmetrical shape.

35. The sealing element according to claim 27, wherein at least one of the first opening and the second opening has an asymmetrical shape.

36. The sealing element according to claim 27, wherein the first opening is arranged behind the second opening.

37. The sealing element according to claim 27, wherein the first opening and the second opening are arranged next to each other in the first direction of extension.

38. The sealing element according to claim 27, wherein a cross-sectional profile of a section of the sealing element has a round shape.

39. The sealing element according to claim 27, wherein a cross-sectional profile of a section of the sealing element has an angular shape.

40. The sealing element according to claim 27, wherein the sealing element further comprises additional openings.

41. The sealing element according to claim 27, wherein the sealing element has one or more grooves in the cylindrical end contour on a radially outer side of the sealing element to form an anti-rotation lock.

42. The sealing element according to claim 27, wherein the sealing element has one or more springs in the cylindrical end contour on a radially outer side of the sealing element to form an anti-rotation lock.

43. The sealing element according to claim 27, wherein the sealing element has one or more grooves in the cylindrical end contour on a radially inner side of the sealing element to form an anti-rotation lock.

44. The sealing element according to claim 27, wherein the sealing element has one or more springs in the cylindrical end contour on a radially inner side of the sealing element to form an anti-rotation lock.

45. The sealing element according to claim 30, further comprising:
an area between the at least one section of the sealing element having a partially cylindrical shape when unwound and a second section of the sealing element having a partially cylindrical shape when unwound,
wherein the area is a predetermined buckling point.

46. The sealing element according to claim 45, wherein the predetermined buckling point has a reduced wall thickness.

47. The sealing element according to claim 45, wherein the predetermined buckling point is made of only one material.

48. The sealing element according to claim 27, wherein at least one of the first material and the second material is an elastomeric material.

49. A method for manufacturing the sealing element according to claim 27, the method comprising:
forming the sealing element in an unwound state by an injection moulding process or a compression moulding process and
forming a cylindrical end contour.

50. The method according to claim 49, wherein first material and the second material are homogeneously or heterogeneously distributed during the injection moulding process or the compression moulding process.

51. The method according to claim 49, wherein the sealing element is annealed after the forming the sealing element in the unwound state.

52. The method according to claim 49, wherein the sealing element is annealed after the forming the cylindrical end contour.

53. The method according to claim 49, wherein the sealing element is at least partially coated before the cylindrical end contour is formed.

54. The method according to claim 49, wherein the sealing element is chemically or mechanically bonded to an additional component during the injection moulding process or compression moulding process.

55. A medium distributor comprising:
a cylindrical rotary slide valve,
a housing, and
the sealing element according to claim 27,
wherein the sealing element seals the cylindrical rotary slide valve with respect to the housing.

56. The medium distributor according to claim 55, wherein the sealing element is rotationally fixed relative to the housing and forms a dynamic sealing surface with the cylindrical rotary slide valve.

57. The medium distributor according to claim 55, wherein the sealing element is rotationally fixed relative to the cylindrical rotary slide valve and forms a dynamic sealing surface with the housing.

58. The medium distributor according to claim 57, wherein the sealing element fulfils the function of a bearing shell for the cylindrical rotary slide valve.
